(19) United States
(12) Patent Application Publication
(10) Pub. No.: US 2013/0130007 A1
(43) Pub. Date: May 23, 2013

(54) METHOD FOR PRODUCING TERMINAL BONDING TAPE, AND TERMINAL BONDING TAPE

(71) Applicant: OKURA INDUSTRIAL CO., LTD., Marugame-shi (JP)

(72) Inventors: Masanao ORIHARA, Marugame-shi (JP); Kazutaka SONODA, Marugame-shi (JP); Kenzo TAKEBAYASHI, Marugame-shi (JP)

(73) Assignee: OKURA INDUSTRIAL CO., LTD., Marugame-shi (JP)

(21) Appl. No.: 13/758,214

(22) Filed: Feb. 4, 2013

Related U.S. Application Data
(63) Continuation-in-part of application No. PCT/JP2011/068017, filed on Aug. 8, 2011.

(30) Foreign Application Priority Data
Aug. 11, 2010 (JP) 2010-180380
Oct. 7, 2010 (JP) 2010-227760

(51) Int. Cl. B32B 37/06; B32B 27/16

(52) U.S. Cl. CPC B32B 37/06; B32B 27/16
USPC 428/218; 156/275.5

(57) ABSTRACT

A method for producing a terminal bonding tape includes providing a multi-layer film having a linear polyethylene surface layer, a linear polyethylene intermediate layer and an acid-modified polyethylene surface layer, and irradiating the multi-layer film with a radiation beam from the side of the linear polyethylene surface layer to cross-link the linear polyethylene intermediate layer. The linear polyethylene surface layer is made of a high-fluidity linear low-density polyethylene having an MFR of 5 to 30 g/10 min or a linear polyethylene with a density of 918 to 940 kg/m³, while the linear polyethylene intermediate layer is made of a low-fluidity linear low-density polyethylene having an MFR of 0.7 to 6 g/10 min or a linear polyethylene with a density of 865 to 917 kg/m³. The radiation cross-linked intermediate layer shows significant reduction in fluidity with the fluidity of the both surface layers being maintained in an acceptable level.

### CROSS-REFERENCE TO RELATED APPLICATION

This application is a continuation-in-part of International Patent Application PCT/JP2011/068017, filed Aug. 8, 2011, which claims, under 35 USC 119, priority of Japanese Patent Applications No. 2010-180380 filed Aug. 11, 2010 and No. 2010-227760 filed Oct. 7, 2010, the entire contents of each of the above PCT and Japanese patent applications being hereby incorporated by reference herein in their entirety.

### BACKGROUND OF THE INVENTION

1. Field of the Invention

The present invention relates to a method for producing a terminal bonding tape which, in a battery or capacitor enclosed in a laminate film, is interposed between the laminate film and a lead terminal, and to a terminal bonding tape.

2. Description of Prior Art

With the increasing demand for smaller and lighter electronic devices, the demand for smaller and lighter batteries for use as power sources thereof is increasing. At the same time, the batteries are required to have a high energy density and a high energy capacity. To satisfy the requirements, the development of non-aqueous electrolyte batteries (such as thin lithium ion batteries), in which a positive electrode, a negative electrode, a separator and a non-aqueous electrolyte are enclosed in a laminate film, is remarkable in recent years.

FIG. 3(A) is a schematic vertical cross-sectional view of an example of a non-aqueous electrolyte battery and FIG. 3(B) is an enlarged cross-sectional view taken along the line a-a′ in FIG. 3(A). A non-aqueous electrolyte battery 30 has power generation elements, such as a positive electrode 35, a negative electrode 36, a separator 37 and a non-aqueous electrolyte (not shown), which are enclosed in a laminate film 32 by heat-sealing the peripheries of the laminate film 32. At this time, a positive electrode lead terminal 33 connected to the positive electrode 35 and a negative electrode lead terminal 34 connected to the negative electrode 36 are bonded to the laminate film 32 via a terminal bonding tape 31 at a heat-sealed portion in a periphery of the laminate film 32 and led out of the battery in a sealed state.

The primary purpose of using the terminal bonding tape 31 between the laminate film 32 and the lead terminals 33 and 34 is to bond the laminate film 32 to the lead terminals 33 and 34. In addition, there are two other purposes. One of them is to improve the seal at lead terminal lead-out portions X. When the laminate film 32 is heat-sealed, the terminal bonding tape 31 is melted moderately and the melted portion flows around the sides of the lead terminals 33 and 34 and fills the gaps between the laminate film 32 and the lead terminals 33 and 34 to improve the seal at the lead terminal lead-out portions X.

The other purpose is to prevent a short-circuit. Because the laminate film 32 usually includes a barrier layer of a metal foil, such as aluminum foil, as one of constituent layers, the barrier layer of the laminate film 32 and the lead terminal 33 or 34 may be short-circuited when located to close to each other. However, when the terminal bonding tape 31 is used, the terminal bonding tape 31 keeps a distance between the barrier layer of the laminate film 32 and the lead terminals 33 and 34 and can therefore prevent a short-circuit due to their close proximity to each other.

To improve the seal at the lead terminal lead-out portions X, it is necessary that the terminal bonding tape 31 is melted moderately and a portion of the terminal bonding tape 31 flows around the sides of the lead terminals 33 and 34 when the peripheries of the laminate film 32 are heat-sealed. However, when the terminal bonding tape 31 is excessively melted, the possibility of a short-circuit increases because the distance between the barrier layer of the laminate film 32 and the lead terminal 33 or 34 decreases. Thus, the terminal bonding tape 31 preferably has a layer which is to be in contact with the lead terminals 33 and 34 and is melted moderately and an intermediate layer which is not melted much during the heat-sealing. A terminal bonding tape having such properties is proposed in Patent Documents 1, 2 and 3.

Patent Document 1 (JP-A-2001-102016) discloses an insulator (terminal bonding tape) having a cross-linked layer composed of a cross-linked polyolefin resin and a thermoplastic layer composed of a thermoplastic resin. The terminal bonding tape provides a seal and insulation when interposed between the lead terminals and the laminate film in such a way that the thermoplastic layer is placed on the lead terminal side and the cross-linked layer is placed on the laminate film side. In other words, the thermoplastic layer is melted so easily during heat-sealing that it not only improves the adhesion between the lead terminals and the terminal bonding tape but also flows around the sides of the lead terminals and improves the seal at the lead terminal lead-out portions. In addition, the cross-linked layer is so unlikely to be deformed during heat-sealing that it keeps a distance between the laminate film and the lead terminals, thereby preventing a short-circuit in the battery. However, the terminal bonding tape cannot provide sufficient adhesion to the laminate film because the cross-linked layer of the terminal bonding tape is placed in contact with the laminate film.

Patent Document 2 (JP-A-2002-279968) discloses a film for a lead wire (terminal bonding tape) composed of a multi-layer film including a cross-linked polyethylene resin layer, a polypropylene layer formed on one side of the cross-linked polyethylene resin layer and an acid-modified polypropylene layer formed on the other side of the cross-linked polyethylene resin layer, and also shows two example methods for producing the terminal bonding tape. In a first method, a polyethylene film is preliminarily subjected to cross-linking and a polypropylene resin and an acid-modified polypropylene resin are applied to respective sides of the polyethylene film by extrusion lamination (section [0018] of Patent Document 2). In a second method, a film prepared by coextrusion of a polypropylene resin, a polyethylene resin and an acid-modified polypropylene resin is subjected to electron beam cross-linking (section [0019]). The acid-modified polypropylene layer is decomposed by electron beam irradiation when it consists only of an acid-modified polypropylene resin, whereas cross-linking takes place between the molecules when an acid-modified polypropylene, to which 5% or more of a polyethylene component, a butene component, a terpolymer component composed of a three-component copolymer of ethylene, butene and propylene or the like has been added, is subjected to electron beam cross-linking (section [0020]).

The terminal bonding tape produced by the first method provides a good seal at the lead terminal lead-out portions and provides good adhesion to the laminate film and to the lead terminals because both the surface layers of the terminal bonding tape have not undergone cross-linking. However, the process is complicated because a film is first formed from a polyethylene resin, then irradiated with an electron beam and thereafter subjected to extrusion lamination to form the surface layers on its both sides. The second method is easy to implement because a terminal bonding tape can be produced by a film formation step and a cross-linking step. However, there is a possibility of poor adhesion between the terminal bonding tape and the lead terminals and a possibility of a poor seal at the lead terminal lead-out portions because the acid-modified polypropylene layer is also irradiated with an electron beam. In addition, because the polypropylene layer of the terminal bonding tape is also irradiated with an electron beam, there is a possibility that the polypropylene layer is decomposed, resulting in poor seal strength between the laminate film and the terminal bonding tape.

Patent Document 3 (JP-A-2003-282035) discloses an adhesive film (terminal bonding tape) having a multi-layer structure including a polyolefin layer to be in contact with a laminate (laminate film), a metal bonding thermal adhesive resin layer to be in contact with a lead wire (lead terminal) and a cross-linked resin layer provided between the polyolefin layer and the metal bonding thermal adhesive resin layer (claim 6 of Patent Document 3). As the cross-linked resin, a polyolefin having an active silane group is used (section [0012]). Because cross-linking is induced in the resin by ambient moisture, cross-linking is allowed to take place only in the intermediate layer after the terminal bonding tape is prepared by coextrusion. However, the active silane group-containing polyolefin, in which cross-linking is induced by moisture, must be stored under strict control to prevent contact with moisture before film formation. In addition, when the resin is used for the intermediate layer, it takes time for the cross-linking reaction to complete because it takes a while for moisture to reach the intermediate layer through the outer layers. Further, an active silane group-containing polyolefin is expensive.

As a method for allowing cross-linking to proceed to a high degree in the intermediate layer without inducing cross-linking in the outer layers in a three-layer film, a thought may occur to add an electron beam cross-linking aid only to the intermediate layer. Prior to the present invention, the present inventors attempted to produce a three-layer film in which an electron beam cross-linking aid was added only to the intermediate layer. However, a large amount of gel was present in the obtained film. This is believed to be because the cross-linking aid induced cross-linking in the resin for the intermediate layer by the effect of heat and pressure during the film formation. In addition, because a cross-linking aid usually has a low molecular weight, it is expected that when a film contains a cross-linking aid, unreacted cross-linking aid bleeds out to the surface of the film with time.

### SUMMARY OF THE INVENTION

It is, therefore, an object of the present invention to provide a very simple method for producing a terminal bonding tape which can reliably seal the lead terminal lead-out portions, can prevent a short-circuit between a lead terminal and the barrier layer of the laminate film, and can provide good adhesion both to the laminate film and to the lead terminals.

In accomplishing the above object, there is provided in accordance with one aspect of the present invention a method for producing a terminal bonding tape, which includes:

providing a multi-layer film having a first surface layer of a first linear polyethylene, a second surface layer of an acid-modified polyethylene, and an intermediate layer of a second linear polyethylene interposed between the first and second surface layers, and

irradiating the multi-layer film with a radiation beam from the side of the first surface layer to cross-link the second linear polyethylene of the intermediate layer,

wherein the first linear polyethylene is selected from the group consisting of (a) a high-fluidity linear low-density polyethylene having an MFR of not lower than 5 g/10 min and not higher than 30 g/10 min and (b) a linear polyethylene with a density of 918 to 940 kg/m³, and the second linear polyethylene is selected from the group consisting of (a′) a low-fluidity linear low-density polyethylene having an MFR which is lower than that of the high fluidity linear low-density polyethylene and which is in the range of not lower than 0.7 g/10 min and not higher than 6 g/10 min and (b′) a linear polyethylene with a density of 865 to 917 kg/m³, with the proviso that when the first linear polyethylene is (a), the second linear polyethylene is (a′) and when the first linear polyethylene is (b), the second linear polyethylene is (b′).

In the above method, the multi-layer film preferably has a thickness of 50 to 300 μm, more preferably 70 to 200 μm. Each of the first surface layer, second surface layer and intermediate layer preferably has a thickness of 10 to 100 μm, more preferably 20 to 70 μm. The radiation beam includes, for example, an electron beam, X-rays and γ-rays. The electron beam irradiation is preferably carried out with a dose of 25 to 200 kGy, more preferably 40 to 100 kGy. The acceleration voltage of 70 to 300 kV may be generally used in the electron beam irradiation. As used herein, MFR (melt flow rate) is as measured according to JIS K7210 at a temperature of 190° C. and a load of 2.16 kg.

The present inventors have conducted the following experiment with the idea that there is some correlation between the “MFR” of a linear low-density polyethylene and its “change in fluidity by cross-linking.”

Three resins with almost the same density were provided. Each resin was formed into a single-layer film with a thickness of 70 μm by T-die extrusion molding, and the films were subjected to electron beam cross-linking under the same conditions. The obtained films were named test samples 1-1 to 1-3. The “remaining thickness” of each of the test samples 1-1 to 1-3 was measured to determine the “change in fluidity by cross-linking.” The measurement of the “remaining thickness” was made under high-temperature and high-pressure conditions under which even a resin with a sufficiently low MFR flows out unless cross-linked so that the result was not affected by the non-fluidity of non-cross-linked resin. Specifically, the test samples 1-1 to 1-3 were each placed on a non-heated sealing mat and a 10 mm wide iron sealing bar heated to 240° C. was pressed thereagainst from above at a contact pressure of 1 MPa for 10 seconds. Then, the remaining thicknesses of the films, which originally had a thickness of 70 μm immediately after the formation, were measured. For the purpose of comparison, similar tapes without having been subjected to the electron beam cross-linking were each tested for the remaining thickness. The results are summarized in Table 1.

TABLE 1

| | Test sample | Test sample | Test sample |
|---|---|---|---|
| | 1-1 | 1-2 | 1-3 |
| Resin density (kg/m³) | 900 | 900 | 905 |
| MFR | 0.8 | 2.0 | 10.0 |
| Remaining thickness (μm) | 0 | 0 | 0 |
| (before electron | | | |
| beam irradiation) | | | |
| Remaining thickness (μm) | 35.4 | 16 | 8.2 |
| (after electron | | | |
| beam irradiation) | | | |

As shown in Table 1, it was found that the decrease in fluidity during heat sealing is greater and the remaining thickness is therefore greater as the MFR is lower even when the electron beam irradiation conditions are the same. The reason for this is not fully clarified but is believed to be as follows.

In general, it is known that there is a correlation between the MFR and the molecular weight of a resin. Namely, a resin with a low MFR has a high molecular weight and a resin with a high MFR has a low molecular weight. Thus, a resin with a lower MFR has a smaller number of molecules per unit volume even when the density is the same. Thus, when linear low-density polyethylenes with different MFRs are irradiated with an electron beam under the same conditions, the number of cross-linking points per molecule will be different even when the number of cross-linking points per unit volume is the same. In other words, a resin with a low MFR and a high molecular weight has a large number of cross-linking points per molecule because the number of molecules is small, whereas a resin with a high MFR and a low molecular weight has a small number of cross-linking points per molecule because the number of molecules is large. Thus, a resin with a low MFR undergoes a significant decrease in fluidity by cross-linking because the number of cross-linking points per molecule is large and the molecules are linked to adjacent molecules at a number of points. In contrast, the fluidity of a resin with a high MFR is maintained because the number of cross-linking points per molecule is small and the molecules are hardly linked to adjacent molecules.

The present inventors have conducted earnest studies based on these findings to solve the problems described above and, consequently, reached the present invention. Thus, in a specific aspect, the present invention provides a method for producing a terminal bonding tape for bonding a laminate film and a lead terminal, including forming a multi-layer film in which a high-fluidity linear low-density polyethylene layer as a first surface layer, a low-fluidity linear low-density polyethylene layer as an intermediate layer and an acid-modified polyethylene layer as a second surface layer are laminated in this order, and irradiating the multi-layer film with an electron beam from the side of the high-fluidity linear low-density polyethylene layer, wherein the high-fluidity linear low-density polyethylene has an MFR of 5 g/10 min or higher and 30 g/10 min or lower, the low-fluidity linear low-density polyethylene has an MFR of 0.7 g/10 min or higher and 6 g/10 min or lower. In this case, the difference in MFR between the high-fluidity linear low-density polyethylene and the low-fluidity linear low-density polyethylene is preferably at least 1.0 g/10 min.

In addition, the present inventors have conducted the following experiment with the idea that there is some correlation between the “density” of a linear low-density polyethylene and its “change in fluidity by cross-linking.”

Three resins with different densities were provided. Each resin was formed into a single-layer film with a thickness of 70 μm by T-die extrusion molding. The films were subjected to electron beam cross-linking under the same conditions. The obtained films were named test samples 2-1 to 2-3.

Then, sealing bars with a width of 10 mm were pressed against the test sample films 2-1 to 2-3 from above and below, and the remaining thickness of each film was measured. The upper sealing bar was made of iron and heated to 240° C., whereas the lower sealing bar was made of rubber and not heated. The sealing bars were pressed against the test samples 2-1 to 2-3 at a contact pressure of 1 MPa for 10 seconds. The results are summarized in Table 2.

TABLE 2

| | Test sample | Test sample | Test sample |
|---|---|---|---|
| | 2-1 | 2-2 | 2-3 |
| Resin density (kg/m³) | 930 | 912 | 900 |
| MFR | 2.0 | 2.0 | 2.0 |
| Remaining thickness (μm) | 20.5 | 24.8 | 28.7 |

As shown in Table 2, the remaining thickness was greater as the resin density was lower even when the electron beam irradiation conditions were the same. This is assumed to be because as the density was lower, cross-linking proceeded to a higher degree and the thermal fluidity decreased by the effect of electron beam irradiation. The reason for this is not fully clarified but is assumed to be as follows.

A linear polyethylene is obtained by copolymerization of ethylene with approximately 2 to 10% by weight of α-olefin, and the resulting polyethylene usually has a lower density as the proportion of a-olefin is greater. Thus, a linear polyethylene has a larger number of side chains and has a larger proportion of tertiary carbons in the molecules as the density is lower. It is known that when a polyethylene resin is irradiated with an electron beam, the hydrogen atoms bonded to the tertiary carbons are detached from the main chain more easily than other hydrogen atoms. It is, therefore, assumed that because the proportion of tertiary carbons is higher and a larger number of hydrogen atoms are detached leaving carbon radicals behind in the main chain, cross-linking is readily induced by the carbon radicals and the degree of cross-linking in the resin increases as the density of the linear polyethylene is lower even when the level of electron beam irradiation is the same.

In light of these facts, the present inventors have found that, when a terminal bonding tape with a three-layer structure is produced by preparing a three-layer film including a first surface layer of a high-density linear polyethylene, an intermediate layer of a low-density linear polyethylene and a second surface layer of an acid-modified polyethylene, and is irradiated with an electron beam from the side of the high-density linear polyethylene layer, the degree of cross-linking in the intermediate layer can be increased while minimizing cross-linking in the surface layers, thereby to solve the above problems.

In a further specific aspect, the present invention provides a method for producing a terminal bonding tape for bonding a laminate film and a lead terminal at a lead terminal lead-out portion of a non-aqueous electrolyte battery enclosed in the laminate film, including forming a multi-layer film in which a linear polyethylene layer with a density of 918 to 940 kg/m³ as a first surface layer, a linear polyethylene layer with a density of 865 to 917 kg/m³ as an intermediate layer and an acid-modified polyethylene layer as a second surface layer are laminated in this order, and irradiating the multi-layer film with an electron beam from the side of the linear polyethylene layer with a density of 918 to 940 kg/m³. In this case, the difference in density between the linear polyethylene layer with a density of 918 to 940 kg/m³ and the linear polyethylene layer with a density of 865 to 917 kg/m³ is preferably at least 10 kg/m³.

In another aspect, the present invention also provides a terminal bonding tape obtainable by any of the above methods. The present invention further provides a terminal bonding tape, comprising:

a first surface layer of a first radiation cross-linked linear polyethylene,

a second surface layer of an acid-modified polyethylene, and

an intermediate layer of a second radiation cross-linked linear polyethylene interposed between the first and second surface layers,

wherein the second radiation cross-linked linear polyethylene has a greater cross-linking point per molecule than that of the first radiation cross-linked linear polyethylene or a greater cross-linking density than that of the first radiation cross-linked linear polyethylene so that when the terminal bonding tape is heated at a temperature sufficient to melt the first surface layer, the first radiation cross-linked linear polyethylene shows a higher fluidity than that of the second radiation cross-linked linear polyethylene.

As a consequence of the above construction, the radiation cross-linked intermediate layer shows significant reduction in fluidity while the fluidity of each of the surface layers is maintained in an acceptable level. Therefore, the terminal bonding tape of the present invention provides good seal and prevention of a short circuit at lead terminal lead-out portions and provides high adhesion to a laminate film and lead terminals when interposed and fusion-bonded therebetween.

### BRIEF DESCRIPTION OF DRAWINGS

Other objects, features and advantages of the present invention will become apparent from the detailed description of the preferred embodiments of the invention which follows, when considered in light of the accompanying drawings in which:

FIG. 1 is a schematic cross-sectional view illustrating a terminal bonding tape according to a first embodiment of the present invention;

FIG. 2 is a schematic cross-sectional view illustrating a terminal bonding tape according to a second embodiment of the present invention;

FIG. 3(A) is a schematic vertical cross-sectional view showing an example of a non-aqueous electrolyte battery; and

FIG. 3(B) is an enlarged cross-sectional view taken along the line a-a′ in FIG. 3(A)

### DETAILED DESCRIPTION OF THE PREFERRED EMBODIMENTS

### First Embodiment

Description is hereinafter made of a method for the production of a terminal bonding tape according to a first embodiment of the present invention. It should be noted that while a method for producing a terminal bonding tape for use primarily in a non-aqueous electrolyte battery is described in the present invention, the present invention is not limited thereto and is also applicable to the production of a terminal bonding tape for use in a battery or capacitor enclosed in a laminate film.

In the following description of the present invention, “high-fluidity linear low-density polyethylene” is referred to as “high-fluidity L-LDPE,” “low-fluidity linear low-density polyethylene” is referred to as “low-fluidity L-LDPE,” and “acid-modified polyethylene” is referred to as “acid-modified PE.” The high-fluidity L-LDPE and low-fluidity L-LDPE generally have a density of 880 to 940 kg/m³.

First, a three-layer film having a high-fluidity L-LDPE layer, a low-fluidity L-LDPE layer and an acid-modified PE layer, which layers are laminated in this order, is formed by what is called a coextrusion method, in which a high-fluidity L-LDPE, a low-fluidity L-LDPE and an acid-modified PE are supplied to different extruders and the resins from the extruders are supplied to one die. Then, the obtained three-layer film is irradiated with an electron beam. At this time, the multi-layer film is irradiated with the electron beam from the side of the high-fluidity L-LDPE layer. The electron beam irradiation conditions may be determined as appropriate based on the thickness of the film, the densities of the high-fluidity L-LDPE and low-fluidity L-LDPE and so on so that cross-linking can proceed sufficiently in the low-fluidity L-LDPE layer. However, when the electron beam reaches the acid-modified PE layer, cross-linking may take place in the acid-modified PE layer, resulting in poor adhesion between the terminal bonding tape and the lead terminals and a poor seal at the terminal lead-out portions. Thus, the irradiation conditions are preferably so selected that the electron beam fully reaches the low-fluidity L-LDPE layer but hardly reaches the acid-modified PE layer. Finally, the multi-layer film irradiated with an electron beam is provided with slits at regular intervals and then cut to a predetermined length, whereby the production of the terminal bonding tape of the present invention is completed. The terminal bonding tape may be bonded to the terminals before being cut to a predetermined length, if desired.

The three-layer film described above may be also produced by what is called an extrusion lamination method, in which a high-fluidity L-LDPE and an acid-modified PE are formed into films separately and then a thermally fused low-fluidity L-LDPE is extruded between the high-fluidity L-LDPE film and the acid-modified PE film, or by what is called a lamination method, in which a high-fluidity L-LDPE, a low-fluidity L-LDPE and an acid-modified PE are formed into films separately and then the films are bonded together. However, when a coextrusion method, such as T-die coextrusion or inflation coextrusion, is used, the number of production steps can be reduced because a three-layer film can be produced by a single-step film formation process.

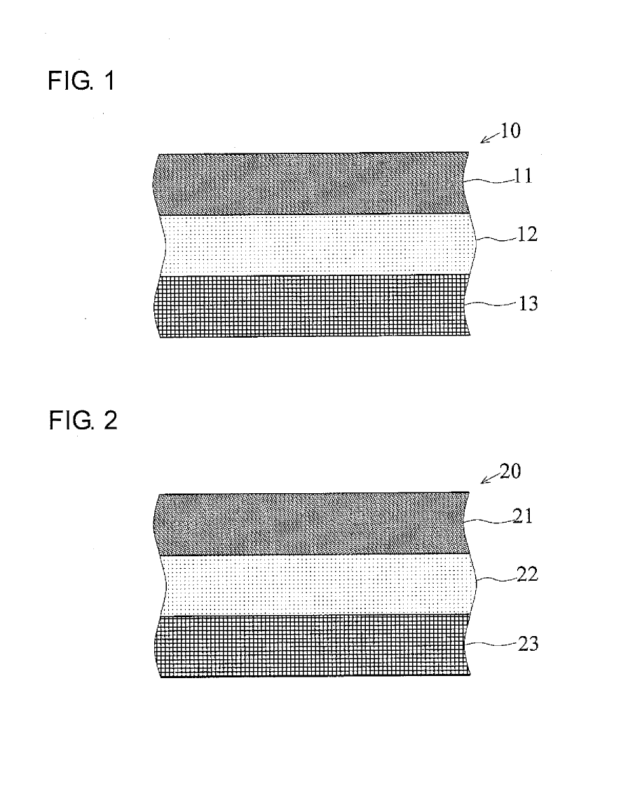

FIG. 1 is a schematic cross-sectional view of a terminal bonding tape 10 according to the present invention. The terminal bonding tape 10 of the present invention includes at least a high-fluidity L-LDPE layer 11 as a first surface layer, an acid-modified PE layer 13 as a second surface layer, and a low-fluidity L-LDPE layer 12 as an intermediate layer interposed between the high-fluidity L-LDPE layer 11 and the acid-modified PE layer 13. The high-fluidity L-LDPE layer 11 and the low-fluidity L-LDPE layer 12 have been cross-linked by electron beam irradiation. It is desired that the cross-linking the acid-modified PE layer 13 have as low a cross-linking degree as possible, particularly preferably a cross-linking degree of substantially zero.

A linear low-density polyethylene resin with an MFR of 5 g/10 min or higher and not higher than 30 g/10 min which is obtained by copolymerization of ethylene and a-olefin is used as a raw material for forming the high-fluidity L-LDPE layer 11. A linear low-density polyethylene resin with an MFR of less than 5 g/10 min does not show sufficiently high fluidity during heat sealing when irradiated with an electron beam under ordinary irradiation conditions, resulting in a poor seal at the lead terminal lead-out portions and poor adhesion between the terminal bonding tape 10 and the laminate film. A linear low-density polyethylene resin with an MFR of higher than 30 g/10 min is not suitable for film formation by extrusion molding.

A linear low-density polyethylene resin with an MFR of not lower than 0.7 g/10 min and not higher than 6 g/10 min which is obtained by copolymerization of ethylene and a-olefin may be used for forming the low-fluidity L-LDPE layer 12. The use of a linear low-density polyethylene resin with an MFR of 0.9 g/10 min or higher and 4 g/10 min or lower is preferred to achieve a significant decrease in fluidity during heat sealing by electron beam cross-linking. A linear low-density polyethylene resin with an MFR of lower than 0.7 g/10 min is difficult to form into a film by extrusion molding. A linear low-density polyethylene resin with an MFR of 4 to 6 g/10 min, especially, 5 to 6 g/10 min, needs irradiation of a high-energy electron beam because the resin does now show a sufficient decrease in fluidity even when subjected to electron beam cross-linking under ordinary irradiation conditions. Further, in this case, a resin with a relatively high MFR should be used for the high-fluidity L-LDPE 11 so that the fluidity of the high-fluidity L-LDPE layer 11 cannot be reduced.

Specifically, the difference in MFR between the resin for forming the high-fluidity L-LDPE layer 11 and the resin for forming the low-fluidity L-LDPE layer 12 should be at least 1 g/10 min, preferably at least 3 g/10 min. When the difference in MFR is less than 1 g/10 min, it is difficult to enable only the intermediate layer to have low fluidity during heat sealing without reducing the fluidity of the surface layer because the difference between their fluidities during heat sealing is eliminated by electron beam irradiation.

A polyethylene resin modified by an acid, such as an unsaturated carboxylic acid, acrylic acid, methacrylic acid or maleic anhydride, is used as a raw material for forming the acid-modified PE layer 13. A polyethylene resin has no polar group and is therefore poor in adhesion to metals. However, the adhesion of the resin to lead terminals made of aluminum, copper or nickel can be improved by acid modification because polar groups can be introduced into the resin. The use of a polyethylene resin modified by maleic anhydride for the acid-modified PE layer 13 is preferred from the viewpoint of adhesion to the lead terminals and economy.

The terminal bonding tape 10 of the present invention may have, if desired, an additional layer between the high-fluidity L-LDPE layer and the low-fluidity L-LDPE layer or between the low-fluidity L-LDPE layer and the add-modified PE layer as long as the effect of the present invention is not impaired.

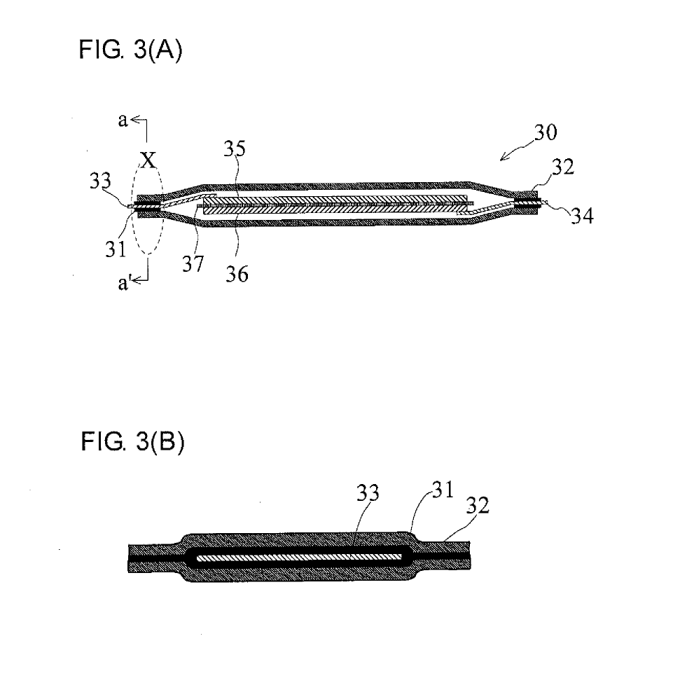

In use, the terminal bonding tape 10 of the present invention is provided between the lead terminals 33 and 34 and the laminate film 32 at lead terminal lead-out portions X of a non-aqueous electrolyte battery enclosed in the laminate film 32 as shown in FIGS. 3(A) and 3(B), for example. At this time, the tape 10 is disposed with the acid-modified PE layer 13 with high adhesion to metals being in contact with the lead terminals 33 and 34 and the high-fluidity L-LDPE layer 11 being in contact with the laminate film 32. In addition, the terminal bonding tape 10 of the present invention is especially suitably used for the production of a battery using a laminate film 32 having a PE-based sealant layer because the layer to be in contact with the laminate film 32 is made of a high-fluidity L-LDPE.

The present invention is described in more detail based on examples and comparative examples. Evaluation was made by the following methods in the examples and comparative examples.

### Adhesion Test

The adhesion between a laminate film as an outer packaging material for a non-aqueous electrolyte battery and the terminal bonding tape was measured. A five-layer film (biaxially-stretched polyethylene terephthalate/biaxially-stretched nylon/aluminum foil/acid-modified polyethylene/linear low-density polyethylene) was used as the laminate film. The laminate film and the terminal bonding tape were stacked in such a way that the linear low-density polyethylene layer of the film was in contact with the high-fluidity L-LDPE layer (the low-fluidity L-LDPE layer in Comparative Example 2) of the terminal bonding tape. The laminate film and the terminal bonding tape were heat-sealed by pressing a sealing bar thereonto from above. At this time, the surface of a sealing mat and the sealing bar were both heated to 150° C. or 170° C., and the sealing was performed for 1.0 second at a sealing pressure of 1 MPa. Then, the adhesion strength was measured by a T-peel test using an autograph. At this time, the distance between the chucks was 40 mm and the crosshead speed was 300 mm/min.

### Insulation Test

The insulation performance was evaluated by pressing a sealing bar from above against the terminal bonding tape placed on a sealing mat. Then, the remaining thickness of the tape was measured. The terminal bonding tape can provide higher insulation as the remaining thickness after sealing is greater because the lead terminals and the laminate film can be separated at a greater distance. The heat sealing was conducted under high-temperature and high pressure conditions (sealing bar (made of iron): 240° C., sealing mat (made of rubber): not heated, contact pressure: 1 MPa, sealing time: 10 seconds).

### Example 1

A high-fluidity L-LDPE, a low-fluidity L-LDPE and an acid-modified PE were supplied to different extruders, and a three-layer film (high-fluidity L-LDPE/low-fluidity L-LDPE/acid-modified PE) was formed by T-die coextrusion. Then, the three-layer film was irradiated with an electron beam from the side of the high-fluidity L-LDPE layer. At this time, the electron beam irradiation was carried out in such a condition that the electron beam did not reach the acid-modified PE layer but reached the low-fluidity L-LDPE. The obtained film was cut into a 100×15 mm piece, whereby a terminal bonding tape of Example 1 was obtained. The MFR of the resin for each layer and the thickness of each layer (before the irradiation) are shown in Table 3. The obtained terminal bonding tape was subjected to the adhesion test and the insulation test. The results are also summarized in Table 3.

### Comparative Example 1-1

A three-layer film (high-fluidity L-LDPE/low-fluidity L-LDPE/acid-modified PE) was formed in the same manner as in Example 1, and the film was cut into a 100×15 mm piece without electron beam irradiation, whereby a terminal bonding tape of Comparative Example 1-1 was obtained. The terminal bonding tape was also subjected to the adhesion test and the insulation test.

### Comparative Example 1-2

A terminal bonding tape was obtained in the same manner as in Example 1 except that a low-fluidity L-LDPE was used instead of the high-fluidity L-LDPE. The terminal bonding tape of Comparative Example 1-2 was also subjected to the adhesion test and the insulation test. The results are summarized in Table 3.

TABLE 3

| | | | | Comparative | Comparative |
|---|---|---|---|---|---|
| | | | Example 1 | Example 1-1 | Example 1-2 |
| Terminal | Surface | Resin | High-fluidity | High-fluidity | Low-fluidity |
| bonding | layer | composition | L-LDPE | L-LDPE | L-LDPE |
| tape | (laminate | MFR | 10 | 10 | 2.0 |
| | film side) | (g/10 min) | | | |
| | | Thickness | 30 | 30 | 30 |
| | | (μm) | | | |
| | Intermediate | Resin | Low-fluidity | Low-fluidity | Low-fluidity |
| | layer | composition | L-LDPE | L-LDPE | L-LDPE |
| | | MFR | 2.0 | 2.0 | 2.0 |
| | | (g/10 min) | | | |
| | | Thickness | 40 | 40 | 40 |
| | | (μm) | | | |
| | Surface | Resin | Acid-modified | Acid-modified | Acid-modified |
| | layer | composition | PE | PE | PE |
| | | MFR | 6.5 | 6.5 | 6.5 |
| | | (g/10 min) | | | |
| | | Thickness | 30 | 30 | 30 |
| | | (μm) | | | |

| Electron beam irradiation | | Done | Not done | Done |
|---|---|---|---|---|
| Adhesion test (N/15 mm) | 150° C. | 134.2 | 133.4 | 61.1 |
| | 170° C. | 145.7 | 151.1 | 103.5 |

| | | | |
|---|---|---|---|
| Insulation test (μm) | 6.3 | 0 | 37.9 |

The terminal bonding tape of Example 1 had substantially the same adhesion as the terminal bonding tape of Comparative Example 1-1, which was not subjected to electron beam irradiation. This is believed to be because the fluidity of the high-fluidity L-LDPE used for the surface layer of the terminal bonding tape of Example 1 was hardly reduced by the electron beam irradiation. The terminal bonding tape of Example 1 had a greater remaining thickness than the terminal bonding tape of Comparative Example 1-1 in the insulation test. This means that the terminal bonding tape of Example 1 can provide better insulation than the terminal bonding tape of Comparative Example 1-1. This is because the fluidity of the intermediate layer of the terminal bonding tapes of Example 1 was significantly reduced as a result of the electron beam cross-linking. In addition, the terminal bonding tape of Comparative Example 1-2, in which the surface layer and the intermediate layer were both made of a low-fluidity L-LDPE, had a significantly large remaining thickness in the insulation test but had poor results in the adhesion test. This is because not only the fluidity of the intermediate layer but also the fluidity of the surface layer (low-fluidity L-LDPE layer) were reduced in the terminal bonding tape by the electron beam irradiation.

### Second Embodiment

Description is hereinafter made of a terminal bonding tape according to a second embodiment of the present invention. FIG. 2 shows a schematic cross-sectional view of a terminal bonding tape 20 of the present invention. The terminal bonding tape 20 of the present invention includes at least a linear polyethylene layer 21 with a density of 918 to 940 kg/m³ as a first surface layer, an acid-modified polyethylene layer 23 as a second surface layer, and a linear polyethylene layer 22 with a density of 865 to 917 kg/m³ interposed between the linear polyethylene layer 21 and the acid-modified polyethylene layer 23. The layers 21 and 22 have been irradiated with an electron beam such that the degree of cross-linking in the linear polyethylene layer 21 with a density of 918 to 940 kg/m³ as the first surface layer is very low, while the degree of cross-linking in the linear polyethylene layer 22 with a density of 865 to 917 kg/m³ as the intermediate layer is high. The acid-modified polyethylene layer 23 as the second surface layer has a cross-linking degree of substantially zero or very low.

In the following, the linear polyethylene with a density of 918 to 940 kg/m³ is referred to as “L-LDPE,” the linear polyethylene with a density of 865 to 917 kg/m³ is referred to as “VLDPE,” and the acid-modified polyethylene is referred to as “acid-modified PE.” The terminal bonding tape 20 of the present invention may have an additional layer between the L-LDPE layer 21 and the VLDPE layer 22 or between the VLDPE layer 22 and the acid-modified polyethylene layer 23, if desired.

A linear polyethylene resin with a density of 918 to 940 kg/m³ which is obtained by copolymerization of ethylene and a-olefin may be used as a raw material for the L-LDPE layer 21. When the density is lower than 918 kg/m³, the resin easily undergoes cross-linking by electron beam irradiation, resulting in a poor seal at the lead terminal lead-out portions or poor adhesion between the terminal bonding tape 20 and the laminate film. When the density is higher than 940 kg/m³, the terminal bonding tape 20 becomes easy to tear in a specific direction because the resin is easily oriented during the film formation.

A linear polyethylene resin with a density of 865 to 917 kg/m³ which is obtained by copolymerization of ethylene and α-olefin may be used for the VLDPE layer 22. The use of a linear polyethylene resin with a density of 865 to 905 kg/m³ is especially preferred for effective cross-linking by means of an electron beam. The lower limit of the density of the VLDPE layer 22 is 865 kg/m³ in the present invention, because a linear polyethylene resin with a density of lower than 865 kg/m³ is difficult to obtain now.

The resin for forming the L-LDPE layer 21 and the resin for forming the VLDPE layer 22 preferably have a difference in density therebetween of at least 10 kg/m³. When the difference in density is less than 10 kg/m³, the electron beam irradiation conditions, under which cross-linking is allowed to proceed to a high degree in the VLDPE layer 22 without inducing cross-linking in the L-LDPE layer 21, are narrowed. A polyethylene resin modified by an acid, such as an unsaturated carboxylic acid, acrylic acid, methacrylic acid or maleic anhydride, is used as raw material for forming the acid-modified PE layer 23. A polyethylene resin has no polar group and is therefore poor in adhesion to metals. However, the adhesion of the resin to lead terminals made of aluminum, copper or nickel can be improved by acid modification because polar groups can be introduced into the resin. The use of a polyethylene resin modified by maleic anhydride for the acid-modified PE layer 23 is preferred from the viewpoint of adhesion to the lead terminals and economy.

A method for the production of the terminal bonding tape 20 according to the second embodiment of the present invention is next described.

According to the present invention, a multi-layer film including an L-LDPE layer, a VLDPE layer and an acid-modified PE layer is first formed. The film formation method is not particularly limited. For example, the multi-layer film may be formed by what is called an extrusion lamination method, in which an L-LDPE and an acid-modified PE are formed into films separately and then a thermally fused VLDPE is extruded between the L-LDPE film and the acid-modified PE film.

Alternatively, the multi-layer film may formed by what is called a coextrusion method, in which an L-LDPE, a VLDPE and an acid-modified PE are supplied to different extruders and the resins from the extruders are supplied to one die. When a coextrusion method, such as T-die coextrusion or inflation coextrusion, is used, the number of production steps can be reduced because a multi-layer film can be produced by a single-step film formation process.

Then, the obtained multi-layer film is irradiated with a radiation beam such as an electron beam in the same manner as that in the first embodiment. The multi-layer film is irradiated with the electron beam from the side of the L-LDPE layer. The electron beam irradiation conditions may be determined as appropriate based on the thickness of the film, the densities of the L-LDPE and VLDPE and so on so that the electron beam can reach the VLDPE layer and induce sufficient cross-linking in the VLDPE layer. However, when the electron beam reaches the acid-modified PE layer, cross-linking may take place in the acid-modified PE layer, resulting in a poor seal at the terminal lead-out portions. Thus, the irradiation conditions are so selected that the electron beam fully reaches the VLDPE layer but hardly reaches the acid-modified PE layer.

Finally, the multi-layer film irradiated with an electron beam is provided with slits at regular intervals and then cut to a predetermined length, whereby the production of the terminal bonding tape 20 is completed.

The terminal bonding tape 20 of the present invention may be provided between the lead terminals 33 and 34 and the laminate film 32 at lead terminal lead-out portions X of a non-aqueous electrolyte battery enclosed in the laminate film 32 as shown in FIGS. 3(A) and 3(B), for example. At this time, the tape 20 is disposed so that the acid-modified PE layer 23 with high adhesion to metals is in contact with the lead terminals 33 and 34 and the L-LDPE layer 21 is in contact with the laminate film 32. In addition, the terminal bonding tape 20 of the present invention is especially suitably used for the production of a battery using a laminate film 32 including a PE-based sealant layer because the layer to be in contact with the laminate film 32 is made of an L-LDPE.

The present invention is described in more detail based on examples and comparative examples. Evaluation was made by the following methods in the examples and comparative examples.

### Adhesion Test

The adhesion between a laminate film for a non-aqueous electrolyte battery and the terminal bonding tape was measured. A five-layer film (biaxially-stretched PET/biaxially-stretched NY/aluminum foil/acid-modified PE/L-LDPE) was used as the laminate film. The laminate film and the terminal bonding tape were stacked in such a way than the L-LDPE layer of the film was in contact with the L-LDPE layer or VLDPE layer of the terminal bonding tape. The laminate film and the terminal bonding tape were heat-sealed by pressing sealing bars from above and below. At this time, the upper and lower sealing bars were both heated to 150° C. or 170° C., and the sealing was performed for 1.0 second at a sealing pressure of 1 MPa.

Then, the adhesion strength was measured by a T-peel test using an autograph. At this time, the distance between the chucks was 40 mm and the tension rate was 300 mm/min.

### Insulation Test

The insulation performance was evaluated by pressing sealing bars with a width of 10 mm against the terminal bonding tape from above and below, and then measuring the remaining thickness of the tape. The terminal bonding tape can provide higher insulation as the remaining thickness after sealing is greater because the lead terminals and the laminate film can be separated at a greater distance. The upper sealing bar was made of iron and heated to 240° C., whereas the lower sealing bar was made of rubber and not heated. The sealing bars were pressed against the test sample films 2-1 to 2-3 at a contact pressure of 1 MPa for 10 seconds.

### Example 2

An L-LDPE, a VLDPE and an acid-modified PE were supplied to different extruders, and a three-layer film (L-LDPE/VLDPE/acid-modified PE) was formed by T-die coextrusion. Then, the three-layer film was irradiated with an electron beam from the side of the L-LDPE layer. At this time, the electron beam irradiation was carried out in such a manner that the electron beam did not reach the acid-modified PE layer. The obtained film was cut into a 100×100 mm piece, whereby a terminal bonding tape of Example 2 was obtained. The density of the resin for each layer and the thickness of each layer (before the irradiation) are shown in Table 4.

The obtained terminal bonding tape was subjected to the adhesion test and the insulation test. The results are also summarized in Table 4.

### Comparative Example 2-1

A three-layer film (L-LDPE/VLDPE/acid-modified PE) was formed in the same manner as in Example 2, and the film was cut into a 100×100 mm piece without electron beam irradiation, whereby a terminal bonding tape of Comparative Example 2-1 was obtained. The terminal bonding tape was also subjected to the adhesion test and the insulation test.

### Comparative Example 2-2

A terminal bonding tape was obtained in the same manner as in Example 2 except that a VLDPE was used instead of the L-LDPE. The terminal bonding tape of Comparative Example 2-2 was also subjected to the adhesion test and the insulation test. The results are summarized in Table 4.

TABLE 4

| | | | | Comparative | Comparative |
|---|---|---|---|---|---|
| | | | Example 2 | Example 2-1 | Example 2-2 |
| Terminal | Surface layer | Resin | L-LDPE | L-LDPE | VLDPE |
| bonding | | composition | | | |
| tape | | Density | 924 | 924 | 900 |
| | | (kg/m³) | | | |
| | | Thickness | 30 | 30 | 30 |
| | | (μm) | | | |
| | Intermediate | Resin | VLDPE | VLDPE | VLDPE |
| | layer | composition | | | |
| | | Density | 900 | 900 | 900 |
| | | (kg/m³) | | | |
| | | Thickness | 40 | 40 | 40 |
| | | (μm) | | | |
| | Surface layer | Resin | Acid-modified | Acid-modified | Acid-modified |
| | | composition | PE | PE | PE |
| | | Density | 914 | 914 | 914 |
| | | (kg/m³) | | | |
| | | Thickness | 30 | 30 | 30 |
| | | (μm) | | | |
| Electron beam irradiation | | | Done | Not done | Done |
| Adhesion test (N/15 mm) | | 150° C. | 134.2 | 133.4 | 61.1 |
| | | 170° C. | 145.7 | 151.1 | 103.5 |

| | | | |
|---|---|---|---|
| Insulation test (μm) | 6.3 | 0 | 37.9 |

The terminal bonding tape of Example 2 had substantially the same adhesion as the terminal bonding tape of Comparative Example 2-1, which was not subjected to electron beam irradiation. This is believed to be because cross-linking was hardly induced in the L-LDPE for the surface layer of the terminal bonding tape of Example 2 by the electron beam. The terminal bonding tape of Example 2 had a greater remaining thickness than the terminal bonding tape of Comparative Example 2-1 in the insulation test. This means that the terminal bonding tape of Example 2 can provide better insulation than the terminal bonding tape of Comparative Example 2-1. This is believed to be because cross-linking proceeded in the intermediate layer of the terminal bonding tape of Example 2 by the effect of the electron beam irradiation. In addition, the terminal bonding tape of Comparative Example 2-2, in which the surface layer and the intermediate layer were both made of a VLDPE with a low density, had a significantly large remaining thickness in the insulation test but had poor results in the adhesion test. This is assumed to be because cross-linking proceeded not only in the intermediate layer but also in the surface layer in the terminal bonding tape by the effect of the electron beam irradiation.

The present invention can be used to produce a terminal bonding tape which, in a non-aqueous electrolyte battery enclosed in a laminate film, is interposed between lead terminals and the laminate film to improve the adhesion therebetween. The present invention, however, can not only used to produce a terminal bonding tape for a non-aqueous electrolyte battery but can also be used to produce a terminal bonding tape for use in a battery or capacitor enclosed in a laminate film. The terminal bonding tape according to the present invention can be used especially suitably for the production of a battery using a laminate film having a PE-based sealant layer because the terminal bonding tape is made of polyethylene resins.

The invention may be embodied in other specific forms without departing from the spirit or essential characteristics thereof. The present embodiments are therefore to be considered in all respects as illustrative and not restrictive, the scope of the invention being indicated by the appended claims rather than by the foregoing description, and all the changes which come within the meaning and range of equivalency of the claims are therefore intended to be embraced therein.

### DESCRIPTION OF REFERENCE NUMERALS

10: terminal bonding tape
11: high-fluidity linear polyethylene layer (high-fluidity L-LDPE)
12: low-fluidity linear polyethylene layer (low-fluidity L-LDPE)
13: acid-modified polyethylene layer (acid-modified PE)
20: terminal bonding tape
21: linear polyethylene layer with density of 918 to 940 kg/m³
22: linear polyethylene layer with density of 865 to 917 kg/m³
23: acid-modified polyethylene layer
30: non-aqueous electrolyte battery
31: terminal bonding tape
32: laminate film
33: positive electrode lead terminal
34: negative electrode lead terminal
35: positive electrode
36: negative electrode
37: separator

What is claimed is:

1. A method for producing a terminal bonding tape, comprising
providing a multi-layer film comprising a first surface layer of a first linear polyethylene, a second surface layer of an acid-modified polyethylene, and an intermediate layer of a second linear polyethylene interposed between the first and second surface layers, and
irradiating the multi-layer film with a radiation beam from the side of the first linear polyethylene layer to cross-link the second linear polyethylene
wherein the first linear polyethylene is selected from the group consisting of (a) a high-fluidity linear low-density polyethylene having an MFR of not lower than 5 g/10 min and not higher than 30 g/10 min and (b) a linear polyethylene with a density of 918 to 940 kg/m³, and the second linear polyethylene is selected from the group consisting of (a′) a low-fluidity linear low-density polyethylene having an MFR which is lower than that of the high-fluidity linear low-density polyethylene and which is in the range of not lower than 0.7 g/10 min and not higher than 6 g/10 min and (b′) a linear polyethylene layer with a density of 865 to 917 kg/m³, with the proviso that when the first linear polyethylene is (a), the second linear polyethylene is (a′) and when the first linear polyethylene is (b), the second linear polyethylene is (b′).

2. The method according to claim 1, wherein a difference in MFR between the high-fluidity linear low-density polyethylene and the low-fluidity linear low-density polyethylene is at least 1.0 g/10 min.

3. The method according to claim 1, wherein a difference in density between the linear polyethylene layer with a density of 918 to 940 kg/m³ and the linear polyethylene layer with a density of 865 to 917 kg/m³ is at least 10 kg/m³.

4. The method according to claim 1, wherein the radiation beam is an electron beam.

5. The method according to claim 1, wherein the multi-layer film has a thickness of 50 to 300 μm.

6. The method according to claim 1, wherein each of the first surface layer, second surface layer and intermediate layer has a thickness of 10 to 100 μm.

7. A terminal bonding tape produced by the method according to claim 1.
